(19) United States
(12) Patent Application Publication
(10) Pub. No.: US 2010/0259475 A1
(43) Pub. Date: Oct. 14, 2010

(54) Angle sensor-based pointer and a cursor control system with the same

(76) Inventors: Chiung-Yau Huang, Pingtung Hsien (TW); Sheng-Chih Shen, Tainan City (TW); Charg-Shi Wu, Taoyuan Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/385,473

(22) Filed: Apr. 9, 2009

(51) Int. Cl. G09G 5/08

(52) U.S. Cl. 345/157

(57) ABSTRACT

An angle sensor-based pointer has an angle sensor, a signal processing unit and a wireless transmitting unit. The angle sensor detects rotation angles of hand movements in at least two directions and accordingly produces voltage signals in response to the rotation angles. The voltage signals are further input to the signal processing unit and transformed to a coordinate signal. The coordinate signal is modulated and transmitted wirelessly through the wireless transmitting unit to a target device for moving a cursor from an original position to a new position.

### BACKGROUND OF THE INVENTION

1. Field of the Invention

The present invention relates to a pointer, and more particularly to a pointer utilizes an angle sensor to detect hand movements in different axes and directly produce voltage signals in response to the detected results, and thus simplifies the signal computation complexity.

2. Description of Related Art

With reference to FIG. 3, the TW 577605 patent discloses a manual wireless cursor control device that can control a cursor to move to target position based on a user's finger operations. Since the user operates the device with his thumb, the hand portion may easily feel tired or pain while using device for a long time.

With referent to FIG. 4, the TW 519263 patent discloses an inertial pointer user an X-axis accelerometer and a Y-axis accelerometer to detect included angles between a gravity axis and the two axes respectively. The detected results of the two accelerometers are output to a low-pass data processing unit for producing a control signal being transmitted to control a television or a computer wirelessly. Since the inertial pointer takes the accelerometers to detect the angles relative to the gravity axis, the user must tilt the inertial pointer while pointing an object. However, because one of the two axes is very different from the pointing direction, the usage of the inertial pointer is inconvenient.

Generally speaking, a hand-held pointer detects the hand movements in two directions. With reference to FIG. 5, the up and down movements of the hand are detected in the X-axis direction, while the left and right movements are detected in the Z-axis direction. Accordingly, the movements of the hand can be represented by θₓ and θ_{z} through integration computations. The Y-axis direction is defined as the pointing direction.

The hand movements in the X and Z directions should be respectively detected by two gyroscopes and use the integration computations to obtain the rotation angles θₓ=∫ωxdt and θ_{z}=∫ωdt. For example, the U.S. Pat. No. 5,898,421 discloses a two-axis gyroscopic pointer and method for controlling the movement of a cursor according to user's hand operations. Although the pointer satisfies the requirements of ergonomics, the two-axis gyroscopic has the drawbacks of large size and high cost. The pointer is an angular velocity-based device and uses a vertical gyroscope and a horizontal gyroscope to detect hand movements.

However, the integration computation often causes problems of integration divergence and noise accumulation, as well as noise amplification. The cursor may arbitrarily move on a display of a computer and cannot be precisely controlled to a target position by a user because of the problem of divergence and noise accumulation. With regard to the problem of noise amplification, the cursor will arbitrarily jump to other places so that the user cannot select a desired object with the cursor.

To overcome the shortcomings, the present invention provides a pointer that uses an angle sensor to detect the hand movements in at least two directions to mitigate or obviate the aforementioned problems.

### SUMMARY OF THE INVENTION

The main objective of the present invention is to provide an angle sensor-based pointer to detect hand movements and accordingly control a cursor on a display. The pointer utilizes the angle sensor, for example an magneto-impedance (MI) sensor, a magneto-resistive (MR) sensor or the like, to produce voltage signals in response to the hand movements, and can further generate a cursor control signal based on the voltage signals. Therefore, complex integration computations for calculating rotation angles can be avoid.

To accomplish the objective, the angle sensor-based pointer comprises an angle sensor, a signal processing unit and a wireless transmitting unit. The angle sensor detects rotation angles of hand movements in at least two directions and accordingly produces voltage signals in response to the rotation angles. The voltage signals are further input to the signal processing unit and transformed to a coordinate signal. The coordinate signal is modulated and transmitted wirelessly through the wireless transmitting unit to a target device for moving a cursor from an original position to a new position

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of an angle sensor-based pointer in accordance with the present invention;

FIG. 2 is an operational view of the angle sensor-based pointer in accordance with the present invention;

FIG. 3 is a perspective view of a manual wireless cursor control device in accordance with the TW 577605 patent;

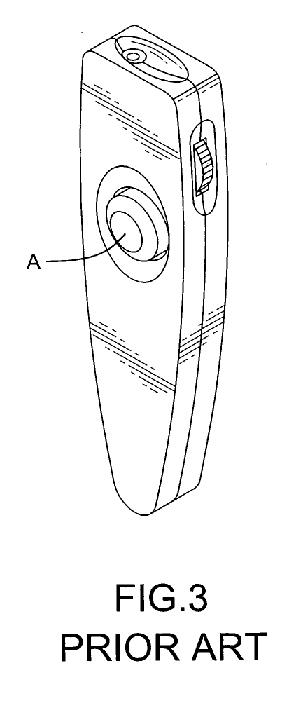

FIG. 4 is a block diagram of an inertial pointer in accordance with the TW 519263 patent; and

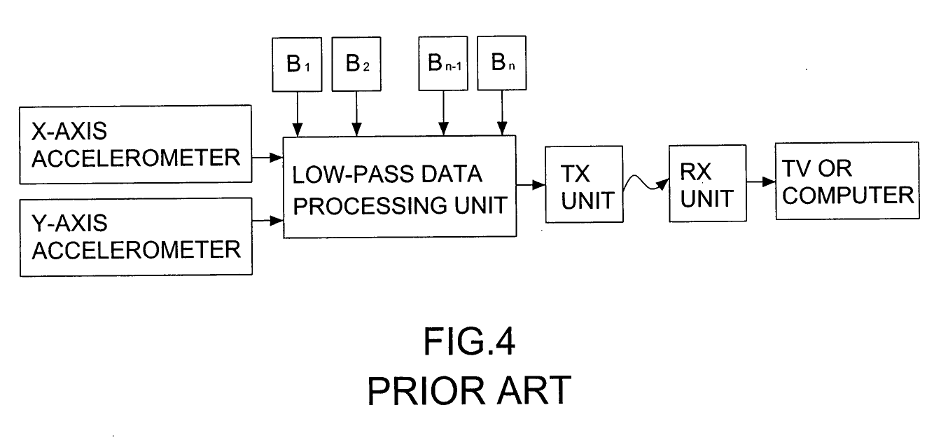

FIG. 5 is a coordinate system for a pointer that detects rotation angles in an X-axis direction and a Z-axis direction.

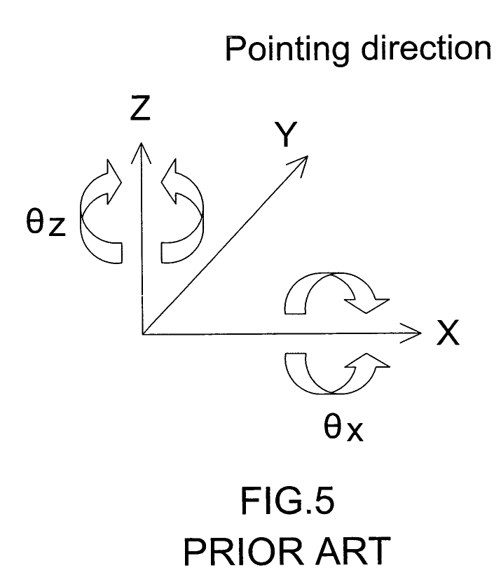

### DETAILED DESCRIPTION OF THE PREFERRED EMBODIMENT

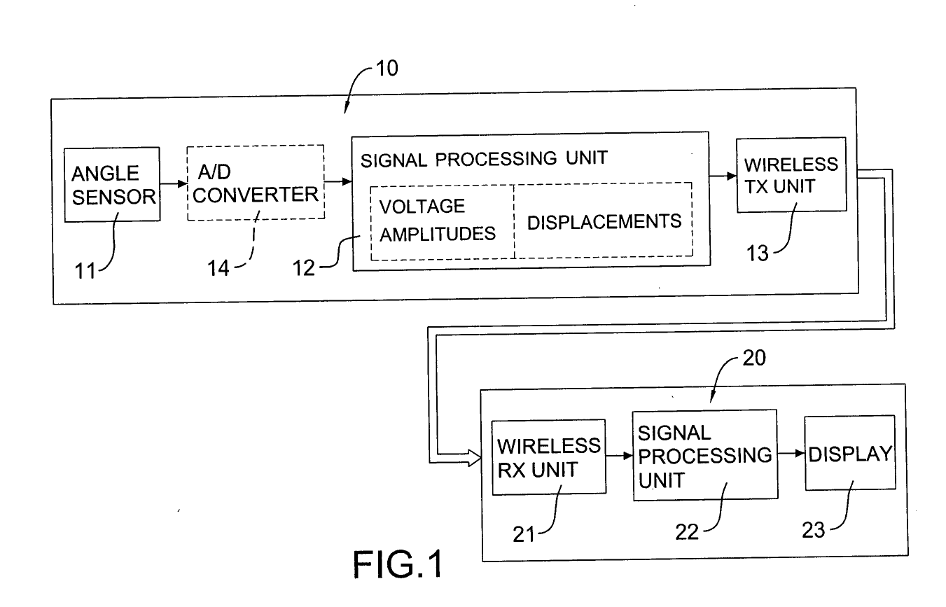

With reference to FIG. 1, an angle sensor-based pointer (10) in accordance with the present invention comprises an angle sensor (11), a signal processing unit (12) and a wireless transmitting unit (13). The pointer (10) may be in the form of a pen, a laser gun for games and the like, and is used to control a target device (20) like a computer, a game host, a video player, a projector etc. The target device (20) comprise a wireless receiving unit (21), a signal processing unit (22) and a display (23).

The angle sensor (11) detects rotation angles of hand movements in at least two directions, for example X-direction and Z-direction, and outputs voltage signals representing the detected results of different directions. Preferably, the angle sensor (11) can be a magneto-impedance (MI) sensor, a magneto-resistive (MR) sensor or the like. For example, an MI sensor of the developed by Aichi Steel Corporation.

The signal processing unit (12) connects to the angle sensor (11) and has a built-in mapping table indicating the relationships between the voltage amplitudes and displacements. Therefore, when the signal processing unit (12) receives the voltage signals from the angle sensor (11), the displacements in different directions of the cursor can be determined by looking up the table. Since the displacements of the cursor are known, the signal processing unit (12) can calculate and locate the new coordinate of the cursor. The signal processing unit (12) thus produces a coordinate signal based on the determined coordinate data. When the voltage signals output from the angle sensor (11) are analog signals, an analog to digital (A/D) converter (14) is provided to convert the analog signals to digital signals to be processed by the signal processing unit (12). The A/D converter (14) may be a separate device connected between the angle sensor (11) and the signal processing unit (12), or a built-in device integrated in the signal processing unit (12).

The wireless transmitting unit (13) connects to the signal processing unit (12) to receive the coordinate signal and transmits the coordinate signal wirelessly to the target device (20).

The coordinate signal is received by the wireless receiving unit (21) and further transformed to a cursor control signal by the signal processing unit (22) to move a cursor shown on the display (23). Therefore, the cursor moves from an original position to a new position according to the cursor control signal.

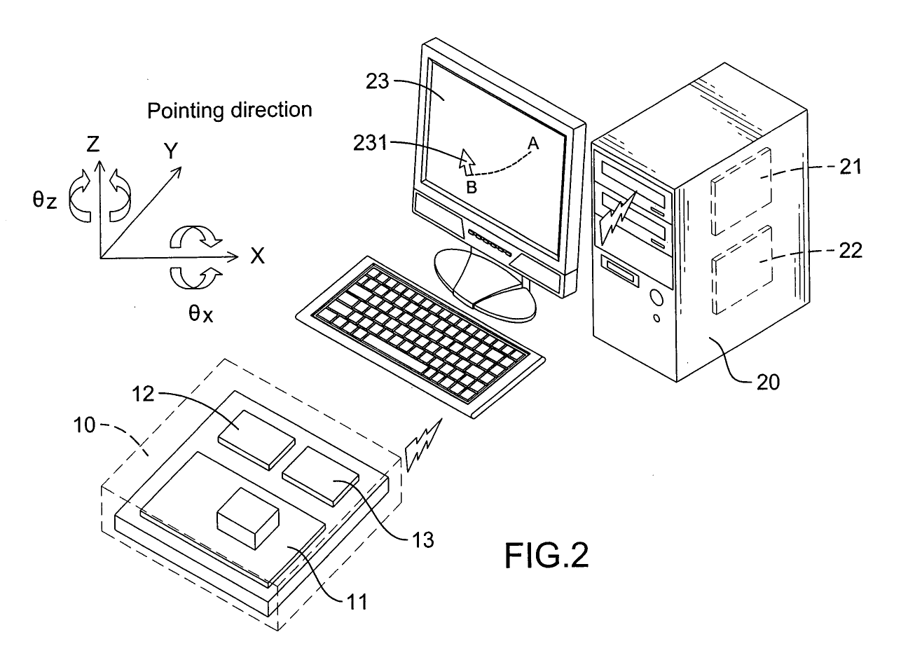

With reference to FIG. 2, a practical application of the present invention is described hereinafter. The user can hold the pointer (10) to control a cursor (231) to move from an original position A to a new position B on the display (23). As the hand moves, the angle sensor (11) detects the hand movements and produces two voltage signals respectively representing the rotation angles in the X-direction and Z-direction. The signal processing unit (12) receives and transforms the two voltage signals to a coordinate signal. The wireless transmitting unit (13) modulates and transmits the coordinate signal wirelessly to the target device (20).

When the wireless receiving unit (21) of the target device (20) receives and demodulates the coordinate signal, the signal processing unit (22) transforms the coordinate signal to a control signal. The control signal is output to the display (23) and moves the cursor (231) on the display (23) from the original position A to a new position B.

The angle sensor-based pointer in accordance with the present invention controls a cursor on a display based on the detected hand movements. Because the angle sensor used in the pointer directly outputs the detected results in the form of voltage signals, the signal processing unit does not need to execute complex integration computations, thus avoid the problems of integration divergence and noise accumulation, as well as noise amplification. Since the size of the angle sensor is relative small in comparison to gyroscopes, the entire volume and manufacturing cost of the pointer can be reduced as small as possible and suitable for hand-held applications.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An angle sensor-based pointer comprising:
an angle sensor detecting rotation angles of hand movements in at least two directions and producing voltage signals in response to the rotation angles;
a signal processing unit connected to the angle sensor, receiving the voltage signals and processing the voltage signals to a coordinate signal for moving a cursor from an original position to a new position; and
a wireless transmitting unit connected to the signal processing unit, receiving the coordinate signal from the signal processing unit and transmitting the coordinate signal wirelessly to a target device.

2. The pointer as claimed in claim 1, wherein the angle sensor detects the rotation angles of the hand movements in an X-axis direction and a Z-axis direction while an Y-axis direction is a pointing direction of the pointer.

3. The pointer as claimed in claim 1, wherein the signal processing unit has a built-in mapping table indicating relationships between voltage amplitudes of the voltage signals and displacements of the cursor.

4. The pointer as claimed in claim 2, wherein the signal processing unit has a built-in mapping table indicating relationships between voltage amplitudes of the voltage signals and displacements of the cursor.

5. The pointer as claimed in claim 3, wherein the voltage signals produced by the angle sensor are analog signals and converted to digital signals by an analog to digital converter.

6. The pointer as claimed in claim 4, wherein the analog to digital converter is connected between the angle sensor and the signal processing unit.

7. The pointer as claimed in claim 5, wherein the analog to digital converter is connected between the angle sensor and the signal processing unit.

8. The pointer as claimed in claim 4, wherein the analog to digital converter is integrated in the signal processing unit.

9. The pointer as claimed in claim 5, wherein the analog to digital converter is integrated in the signal processing unit.

10. The pointer as claimed in claim 6, wherein the angle sensor is a magneto-impedance sensor or a magneto-resistive sensor.

11. The pointer as claimed in claim 7, wherein the angle sensor is a magneto-impedance sensor or a magneto-resistive sensor.

12. The pointer as claimed in claim 8, wherein the angle sensor is a magneto-impedance sensor or a magneto-resistive sensor.

13. The pointer as claimed in claim 9, wherein the angle sensor is a magneto-impedance sensor or a magneto-resistive sensor.

14. A cursor control system comprising:
an angle sensor-based pointer having
an angle sensor detecting rotation angles of hand movements in at least two directions and producing voltage signals in response to the rotation angles;
a first signal processing unit connected to the angle sensor, receiving the voltage signals and processing the voltage signals to a coordinate signal for moving a cursor from an original position to a new position; and
a wireless transmitting unit connected to the first signal processing unit, receiving the coordinate signal from the signal processing unit and transmitting the coordinate signal wirelessly;
a target device having
a wireless receiving unit receiving the coordinate signal from the pointer;
a second signal processing unit connected to the wireless receiving unit to transform the coordinate signal to a cursor control signal; and
a display receiving the cursor control signal, wherein a cursor on the display is controlled to desired positions based on the cursor control signal.

15. The cursor control system as claimed in claim 14, wherein the angle sensor detects the rotation angles of the hand movements in an X-axis direction and a Z-axis direction while an Y-axis direction is a pointing direction of the pointer.

16. The cursor control system as claimed in claim 14, wherein the first signal processing unit has a built-in mapping table indicating relationships between voltage amplitudes of the voltage signals and displacements of the cursor.

17. The cursor control system as claimed in claim 15, wherein the first signal processing unit has a built-in mapping table indicating relationships between voltage amplitudes of the voltage signals and displacements of the cursor.

18. The cursor control system as claimed in claim 17, wherein the voltage signals produced by the angle sensor are analog signals and converted to digital signals by an analog to digital converter in the pointer.

19. The cursor control system as claimed in claim 14, wherein the angle sensor is a magneto-impedance sensor or a magneto-resistive sensor.

20. The cursor control system as claimed in claim 18, wherein the angle sensor is a magneto-impedance sensor or a magneto-resistive sensor.
